(19) United States
(12) Patent Application Publication
(10) Pub. No.: US 2003/0182832 A1
(43) Pub. Date: Oct. 2, 2003

(54) Decorative device having agitable decorative members

(76) Inventor: Yeong-Shyan Hsueh, Taipei Hsien (TW)

Correspondence Address: Yeong-Shyan Hsueh, 235 Chung-Ho, P.O. BOX 10-69, Taipei, TW

(21) Appl. No.: 10/421,036

(22) Filed: Apr. 24, 2003

Related U.S. Application Data
(63) Continuation-in-part of application No. 09/988,149, filed on Nov. 19, 2001.

(51) Int. Cl. G09F 19/00

(52) U.S. Cl. 40/406

(57) ABSTRACT

A decorative device includes a cover secured to a housing for forming a water tight scaled chamber and for receiving a fluid or one or more decorative members. An agitator is rotatably received in the cover for agitating the decorative members or the fluid. A seat is rotatably received in the housing and secured to the agitator, and a cable is secured to the seat for rotating the seat against a spring or the like. One or more light devices or buzzers are attached to the housing, and can be energized alternatively by conductors in the seat and the housing.

The present invention is a continuation in part (CIP) of the U.S. patent Ser. No. 09/988,149, filed at Jul. 6, 2001, assigned to the inventor of the present invention. Thereby, the specification of the U.S. patent Ser. No. 09/899,149 is incorporated into the present invention as part of the specification of the present invention.

### BACKGROUND OF THE INVENTION

1. Field of the Invention

The present invention relates to a decorative device, and more particularly to a decorative device having an agitator for agitating or moving one or more movable decorative members.

2. Description of the Prior Art

Typical key rings can have a plate or a decorative device secured thereto. The plate can having the patterns or words applied thereon, and can not have the other decorative members disposed therein.

The present invention has arisen to mitigate and/or obviate the afore-described disadvantages of the conventional decorative devices.

### SUMMARY OF THE INVENTION

The primary objective of the present invention is to provide a decorative device including one or more movable decorative members disposed therein for decorative purposes.

The other objective of the present invention is to provide a decorative device including an agitator for agitating or moving the movable decorative members.

The further objective of the present invention is to provide a decorative device including one or more light devices or one or more buzzers for generating a light or a sound or the like.

In accordance with one aspect of the invention, there is provided a decorative device comprising a housing, a cover secured to the housing and including a chamber formed therein, at least one decorative member received in the chamber of the cover, and means for agitating the decorative member.

The agitating means includes an agitator rotatably received in the chamber of the cover, and means for rotating the agitator. The rotating means includes a rotary seat rotatably received in the housing and seat for rotating the seat. A spring biasing device can further be provided for recovering the seat.

The seat includes an upper chamber formed therein, and a lid secured in the upper chamber of the seat and secured to the agitator. The seat includes at least one depression formed therein, the lid includes at least one projection engaged in the depression of the seat such that the lid and the seat rotated in concert with each other.

A board is secured in the housing and includes a shaft extended therefrom, the seat is rotatably secured onto the shaft. One or more light devices and/or one or more buzzers and/or one or more electric facilities are attached to the housing, and means for energizing the electric facility and for lighting the decorative members, or for generating the sounds.

The housing includes two first conductors provided therein, the alternatively energizing means includes a rotary seat rotatably received in the housing and having two second conductors provided therein for alternatively contacting with the first conductors when the seat is rotated relative to the housing. A fluid is preferably further provided and received in the chamber of the cover for floating the decorative members.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a decorative device in accordance with the present invention;

FIG. 2 is a perspective view of the decorative device;

FIGS. 3 and 4 are bottom perspective views showing the upper and the lower housing members of the decorative device;

FIGS. 5, 6 are cross sectional views taken along lines 5-5 and 6-6 of FIG. 1 respectively;

FIG. 7 is an electric circuit showing the energizing of the light devices and the buzzer or the other electric facilities;

FIG. 8 is a perspective view illustrating the operation of the decorative device;

FIG. 9 is a perspective view illustrating the other embodiment of the decorative device;

FIG. 10 is an exploded view of the decorative device as shown in FIG. 9;

FIG. 11 is a cross sectional view taken along lines 11-11 of FIG. 9; and

FIG. 12 is a perspective view illustrating the further embodiment of the decorative device.

### DETALED DESCRIPTION OF THE PREFERRED EMBODIMENT

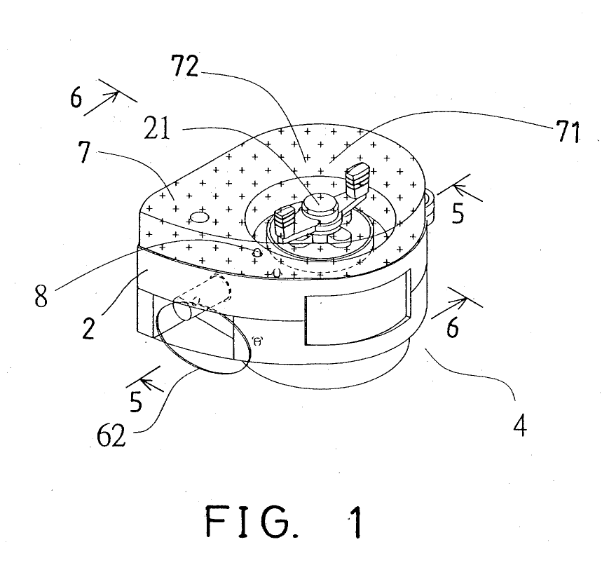

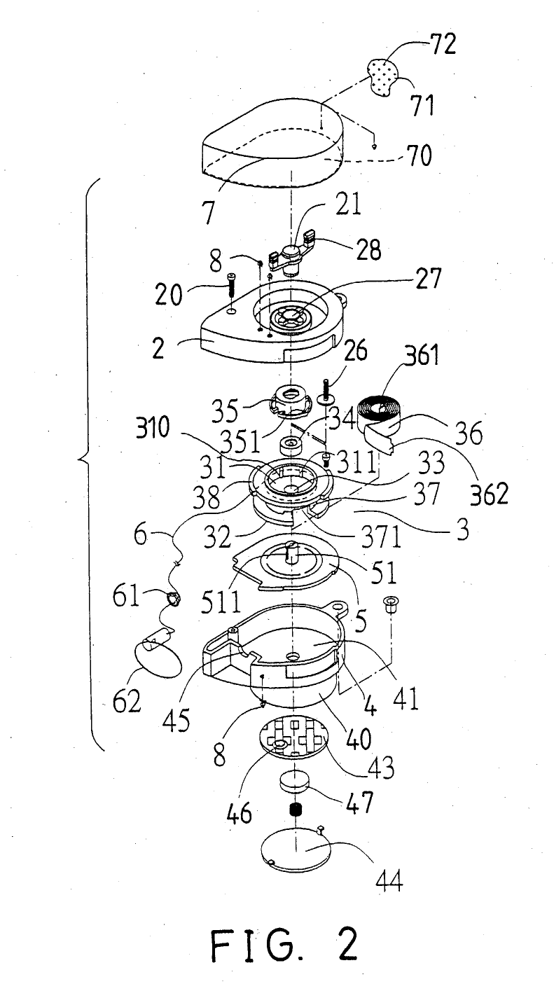

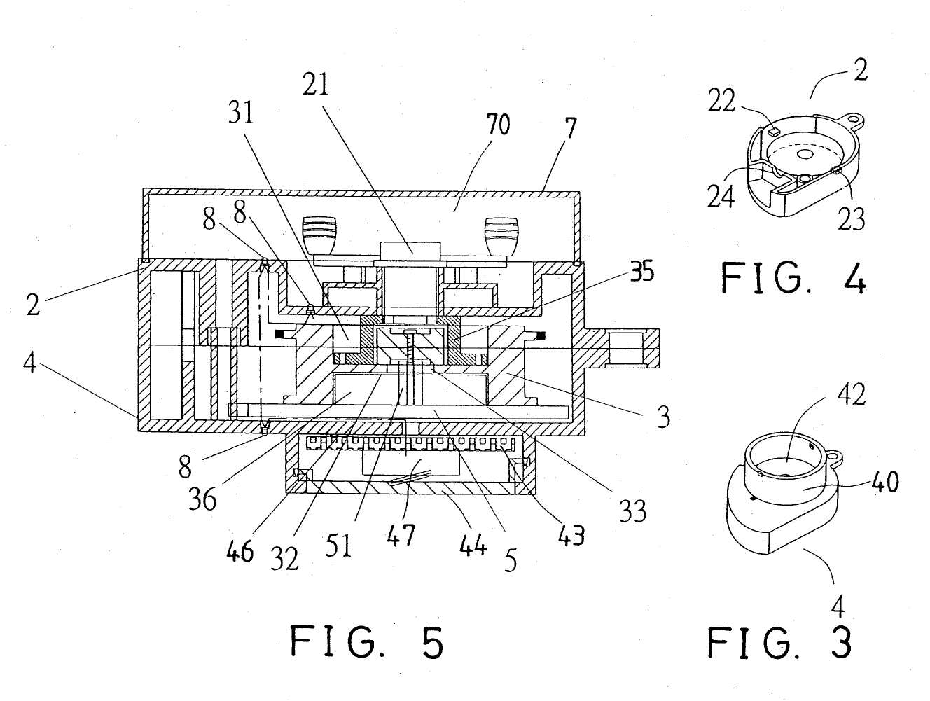

Referring to the drawings, and initially to FIGS. 1-6, a decorative device in accordance with the present invention comprises a housing including two housing members 2, 4 secured together with fasteners 20, or adhesive materials, or with a force-fitted engagement, or by a welding processes or the like. The lower housing member 4 includes a space 42 formed in the bottom portion thereof and formed or defined by a receptacle 40 or the like for receiving a circuit board 43 and one or more batteries 47 therein. A cap 44 can be secured to the receptacle 40 for securing or retaining the circuit board 43 and the batteries 44 within the receptacle 40. one or more buzzers 46 or the other electric facilities can be disposed on or coupled to the circuit board 43 and energized by the batteries 47. the lower housing member 4 includes a chamber 41 formed in the upper portion thereof, and includes a semi-circular notch 45 formed therein and communicating with the chamber 41 thereof. The upper housing member 2 also includes a semi-circular notch 24 formed therein (FIG. 4), for forming as a circular opening together with the semi-circular notch 45 of the lower housing member 4.

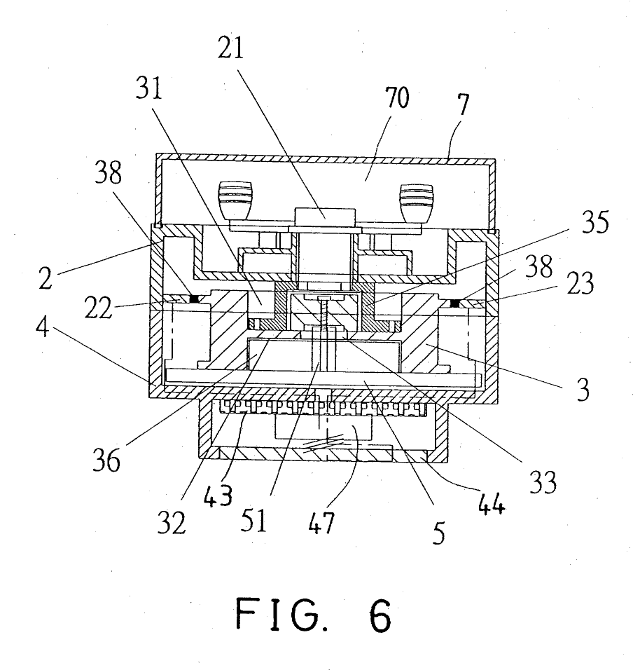

A board 5 is secured in the chamber 41 of the lower housing member 4 with such as the fasteners, or the adhesive materials, or with a force-fitted engagement, or the like. The board 5 includes a shaft 51 extended upward therefrom and having a slit 511 formed therein. A rotary seat 3 is received in the chamber 41 of the lower housing member 4 and includes bore 33 formed therein for receiving the shaft 51 and for rotatably securing to the board 5 and thus the lower housing member 4 with the shaft 51 and/or with one or more bearings 34. The seat 3 includes a lower chamber 32 formed therein (FIGS. 5, 6) for receiving a coil spring 36 therein, and includes a peripheral recess 37 formed in the outer peripheral portion thereof and passage 371 formed therein and communicating with the lower chamber 32 and the peripheral recess 37 thereof. The coil spring 36 includes an inner end 371 engaged in the slit 511 of the shaft 51 and an outer end 372 extended outward through the passage 371 of the seat 3 and secured to the seat 3, such that the coil spring 36 can apply a recovering force against the seat 3.

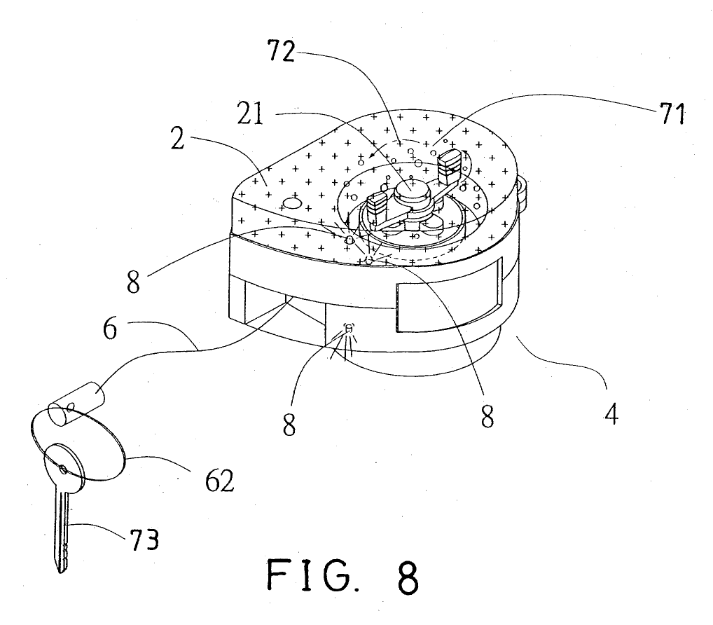

A rope or a wire or a cable 6 or the like can be coiled or wound around the seat 3 and received in the peripheral recess 37 of the seat 3. a gasket 61 is engaged in the circular opening formed by the semi-circular notch 45 of the lower housing member 4 and the semi-circular notch 24 of the upper housing member 2, for threading or protecting the cable 6. A ring 62 or a knob or the like is secured to the free end of the cable 6 for pulling the cable 6 outward of the housing members 2, 4 and for rotating the rotary seat 3 against the spring 36. One or more keys 73 (FIGS. 8, 9, 12) can apply the recovering force against the seat 3, in order to recover the seat 3 after the seat 3 has been rotated or pulled by the cable 6.

The seat 3 includes an upper chamber 31 formed therein and defined by an inner peripheral surface 310, and includes one or more depressions 311 formed in the inner peripheral surface 310 thereof and communicating with the upper chamber 31 thereof. A lid 35 is received in the upper chamber 31 of the seat 3 and has one or more projections 351 laterally extended outward therefrom the engaging with the depressions 311 of the seat 3 and for securing to the seat 3 and thus for being rotated in concert with the seat 3. An agitator 21 has a lower portion extended downward through the orifice 27 of the upper housing member 2 and secured to the lid 35 with such as the fastener 26 and includes one or more fins 28 extended therefrom or provided thereon. A sealing ring (not shown) or the like can be disposed between the agitator 21 and the upper housing member 2, or between the upper housing member 2 and the lid 35 for making a water tight seal therebetween, and for preventing water or liquid from flowing through the orifice 27 of the upper housing member 2.

A cover 7 is secured onto the upper portion of the upper housing member 2. A sealing ring (not shown) or the like can be disposed between the cover 7 and the upper housing member 2 for making a water tight seat therebetween. Alternatively, the cover 7 can also be welded to the upper housing member 2 with such as the ultrasonic welding process, for forming a water tight chamber 70 therein, and for receiving a liquid 71 and one or more movable or floatable decorative members 72 therein. The liquid 71 can include various kinds of colors. The decorative members 72 preferably made of glossy or shiny materials.

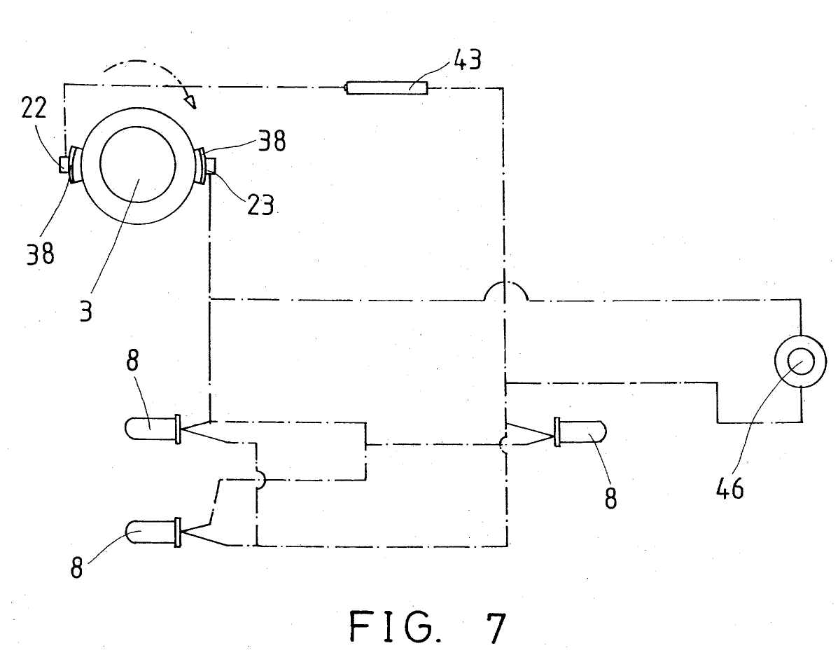

The upper housing member 2 includes two conductors 22, 23 disposed therein and separated from each other. One or more light bulbs or light devices 8 are coupled in parallel to the conductors 22, 23 respectively, best shown in FIG. 7, with electric cables or wires or conductor blades or the like. The buzzers 46 can also be coupled in parallel to the conductors 22, 23 respectively. The circuit board 43 is coupled to one of the conductors 22. The seat 3 includes two conductors 38 disposed therein and separated from each other for contacting or for electrically coupling to the conductors 22, 23 alternatively or in a reciprocating action (FIG. 7), for electrically coupling the poles of the light devices 8 and/or the buzzers 46 and/or the other electric facilities together, and for actuating or energizing the light devices 8 and/or the buzzers 46 and/or the other electric facilities. The seat 3 can include a cable or a wire or a conductor blade (not shown) disposed therein and coupled between the conductors 38, or can be formed by a conductor material for electrically coupling the conductors 38 together. The housing member 2, 4 and the board 5 and the shaft 51 and the lid 35 and the agitator 21 are preferably made of non-conductive materials.

In operation, the seat 3 and thus the agitator 21 can be rotated by the cable 6 when the cable 6 is pulled outward of the housing members 2, 4 against the coil spring 36. When the cable 6 is released, the coil spring 36 can rotate the seat 3 and thus the agitator 21 backward. The conductors 38 of the seat 3 can be caused to be contacted with the conductors 22, 23 of the upper housing member 2 alternatively, or in a reciprocating action, in order to energize the light devices 8 (FIG. 8) and/or the buzzers 46 and/or the other electric facilities alternatively or repeatedly.

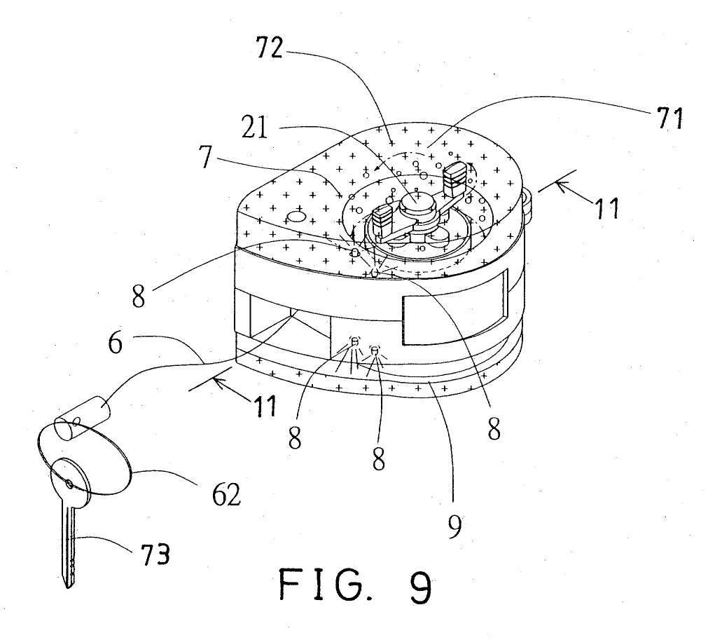

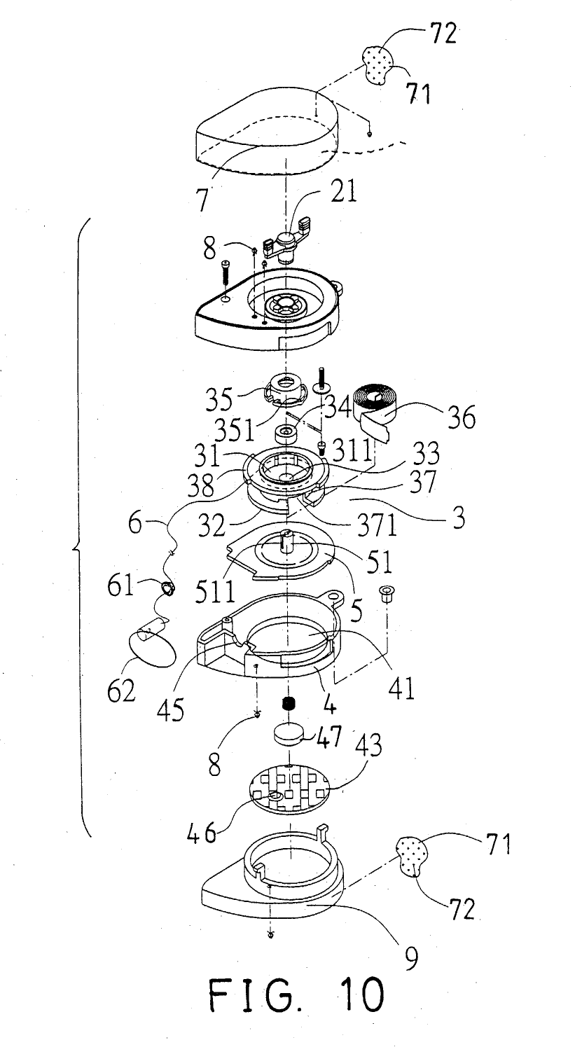

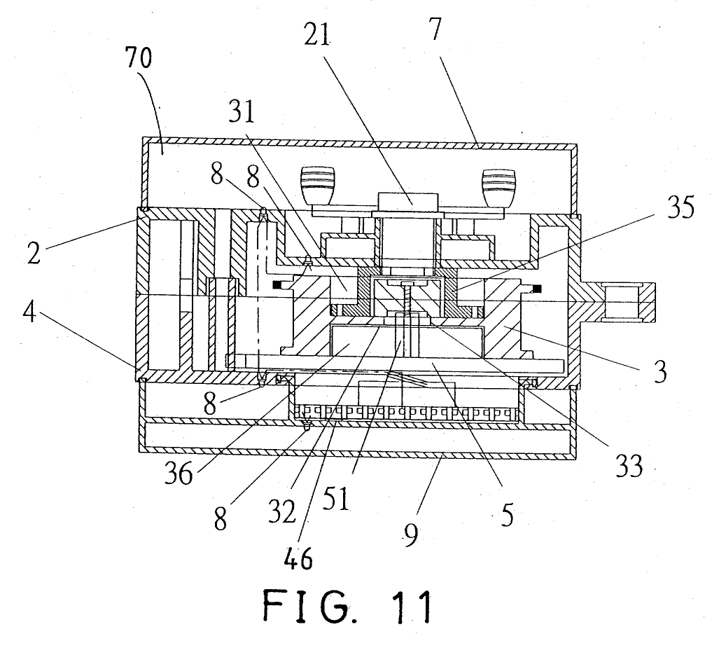

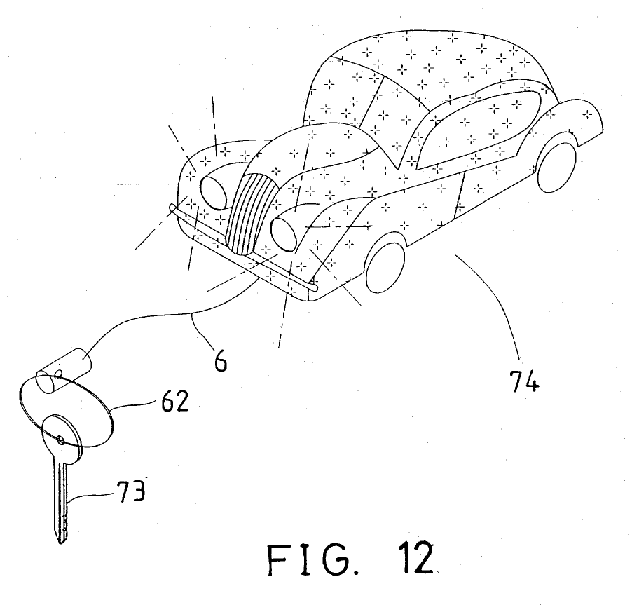

As shown in FIGS. 9-11, a container 9 can also be provided and secured to the lower housing member 4 for receiving the fluid 71 and the decorative members 72 therein. The light devices 8 can be used to light the fluid 71 and the decorative members 72 for decorative purposes. As shown in FIG. 12, the decorative device can include a housing 74 formed into various kinds of shapes, such as the vehicle shape as shown in FIG. 12, for decorative purposes.

Accordingly, the decorative device in accordance with the present invention includes one or more movable decorative members disposed therein for decorative purposes, and/or includes an agitator for agitating or moving the movable decorative members, and/or includes one or more light devices or one or more buzzers for generating a light or a sound or the like.

Although this invention has been described with a certain degree of particularity, it is to be understood that the present disclosure has been made by way of example only and that numerous changes in the detailed construction and the combination and arrangement of parts can be resorted to without departing from the spirit and scope of the invention as hereinafter claimed.

I claim:

1. A decorative device comprising:
a housing including two housing members secured together; the two housing members being:
a lower housing member including a space formed in the bottom portion thereof and formed by a receptacle for receiving a circuit board and at least one battery; a cap being secured to a receptacle for securing the circuit board and the battery within the receptacle; at least one buzzer being disposed on the circuit board and energized by the battery; the lower housing member including a chamber formed in an upper portion thereof, and including a semi-circular notch formed therein and communicating with the chamber thereof;
an upper housing member including a semi-circular notch formed therein for forming as a circular opening together with the semi-circular notch of the lower housing member;
a cover secured to said housing and including a chamber formed therein, a cover being secured onto an upper portion of the upper housing member; the cover and the upper housing member being tightly secured for making a water tight seat;
at least one decorative member received in said chamber of said cover, and
means for agitating said at least one decorative member.

2. The decorative device according to claim 1, wherein said agitating means includes an agitator rotatably received in said chamber of said cover, and means for rotating said agitator.

3. The decorative device according to claim 2, wherein said rotating means includes a rotary seat rotatably received in said housing and secured to said agitator, and a cable secured to said seat for rotating said seat.

4. The decorative device according to claim 3 further comprising means for recovering said seat.

5. The decorative device according to claim 3, wherein said seat includes an upper chamber formed therein, and a lid secured in said upper chamber of said seat and secured to said agitator.

6. The decorative device according to claim 5, wherein said seat includes at least one depression formed therein, said lid includes at least one projection engaged in said at least one depression of said seat such that said lid and said seat rotated in concert with each other.

7. The decorative device according to claim 3 further comprising a board secured in said housing and including a shaft extended therefrom, said seat is rotatably secured onto said shaft.

8. The decorative device according to claim 1 further comprising at least one light device attached to said housing, and means for energizing said at least one light device.

9. The decorative device according to claim 1, wherein the chamber of the cover receives water therein, and the water have various colors so as to present a beautiful outlook.

10. The decorative device according to claim 1 further comprising at least one electric facility attached to said housing, and means for alternatively energizing said at least on electric facility.

11. The decorative device according to claim 10, wherein said housing includes two first conductors provided therein, said alternatively energizing means includes a rotary seat rotatably received in said housing and having two second conductors provided therein for alternatively contacting with said first conductors when said seat is rotated relative to said housing.
